(19) United States
(12) Patent Application Publication
(10) Pub. No.: US 2007/0087233 A1
(43) Pub. Date: Apr. 19, 2007

(54) System and method of controlling fuel cell shutdown

(76) Inventors: Janusz Blaszczyk, Richmond (CA); David A. Summers, Vancouver (CA); Anthony G.W. Cochrane, Vancouver (CA); Andrew J. Henderson, Port Gentil (GA); Richard G. Fellows, Vancouver (CA); Steven E. Houlberg, Vancouver (CA); Michael T. Davis, Port Coquitlam (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/580,524

(22) Filed: Oct. 12, 2006

Related U.S. Application Data
(60) Provisional application No. 60/725,857, filed on Oct. 12, 2005.

(51) Int. Cl. H01M 8/04

(52) U.S. Cl. 429/13; 429/22

(57) ABSTRACT

A system and method for implementing a fuel cell shutdown process are disclosed. Briefly described, one embodiment comprises establishing an oxidant recirculation path from a portion of the cathode flow path upon initiation of the fuel cell shutdown process, wherein the oxidant is recirculated during an oxygen depletion phase to substantially deplete oxygen residing therein to form a substantially oxygen-free fluid; and establishing an anode purge path from a portion of the cathode flow path and the anode flow path by means of a diverter valve, wherein the anode purge path is established upon completion of the oxygen depletion phase, and wherein the substantially oxygen-free fluid is transferred to the anode flow path to substantially purge out the fuel therein during a hydrogen purge phase.

### CROSS-REFERENCE TO RELATED APPLICATION

This application claims the benefit under 35 U.S.C. § 119(e) of U.S. Provisional Patent Application No. 60/725,857, filed Oct. 12, 2005.

### FIELD OF THE INVENTION

This disclosure generally relates to fuel cell systems, and more particularly to power system architectures suitable for fuel cell shutdown.

### DESCRIPTION OF THE RELATED ART

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area.

One type of electrochemical fuel cell is the proton exchange membrane (PEM) fuel cell. PEM fuel cells generally employ a membrane electrode assembly (MEA) comprising a solid polymer electrolyte or ion-exchange membrane disposed between two electrodes. Each electrode typically comprises a porous, electrically conductive substrate, such as carbon fiber paper or carbon cloth, which provides structural support to the membrane and serves as a fluid diffusion layer. The membrane is ion conductive, typically proton conductive, and acts both as a barrier for isolating the reactant streams from each other and as an electrical insulator between the two electrodes. A typical commercial PEM is a sulfonated perfluorocarbon membrane sold by E.I. Du Pont de Nemours and Company under the trade designation NAFION®. The electrocatalyst is typically a precious metal composition (e.g., platinum metal black or an alloy thereof) and may be provided on a suitable support (e.g., fine platinum particles supported on a carbon black support).

In a fuel cell, an MEA is typically interposed between two separator plates that are substantially impermeable to the reactant fluid streams. The plates typically act as current collectors and provide support for the MEA. In addition, the plates may have reactant channels formed therein and act as flow field plates providing access for the reactant fluid streams to the respective porous electrodes and providing for the removal of reaction products formed during operation of the fuel cell.

In a fuel cell stack, a plurality of fuel cells are connected together, typically in series, to increase the overall output power of the assembly. In such an arrangement, one side of a given separator plate may serve as an anode flow field plate for one cell and the other side of the plate may serve as the cathode flow field plate for the adjacent cell. In this arrangement, the plates may be referred to as bipolar plates. Typically, a plurality of inlet ports, supply manifolds, exhaust manifolds and outlet ports are utilized to direct the reactant fluid to the reactant channels in the flow field plates. The supply and exhaust manifolds may be internal manifolds, which extend through aligned openings formed in the flow field plates and MEAs, or may comprise external or edge manifolds, attached to the edges of the flow field plates.

A broad range of reactants can be used in PEM fuel cells. For example, the fuel stream may be substantially pure hydrogen gas, a gaseous hydrogen-containing reformate stream, or methanol in a direct methanol fuel cell. The oxidant may be, for example, substantially pure oxygen or a dilute oxygen stream such as air.

During normal operation of a PEM fuel cell stack, fuel is electrochemically reduced on the anode side, typically resulting in the generation of protons, electrons, and possibly other species depending on the fuel employed. The protons are conducted from the reaction sites at which they are generated, through the membrane, to electrochemically react with oxygen in the oxidant on the cathode side. The electrons travel through an external circuit providing useable power and then react with the protons and oxygen on the cathode side to generate product water.

Prior art fuel cell systems may flush out or purge the flow fields of residual reactants, such as hydrogen and oxygen, for a variety of reasons. For example, purging occurs during a fuel cell system shutdown process whereby electrical generation of the fuel cell is no longer required. Purging of the reactants prevents the occurrence of high potentials in the fuel cell after shutdown. Such high potentials may degrade fuel cell components, such as by corrosion of the carbonaceous components, and thereby decrease durability of the fuel cell. Purging may be accomplished by means of a compressor, a blower, a fan, an ejector, or a pump to flush out the residual reactants with air or an inert gas. In other prior art fuel cell systems, the reactants may be consumed either by combustion inside the fuel cell stack to form substantially inert fluids therein, or by combustion outside the fuel cell stack to form substantially inert fluids that are then recirculated through the anode and the cathode, so that only substantially inert fluids remain inside the fuel cell stack. During a fuel cell stack startup, the fuel cell system supplies with the appropriate reactants into the anode and the cathode, and the electrochemical process is started.

One exemplary fuel cell shutdown process and purging system is disclosed in the Patent Cooperation Treaty (PCT) patent application publication 2005/036682 A1, hereinafter referred to as the '682 application. During fuel cell shutdown, a recirculation loop is coupled to a fuel cell cathode to ensure that fluids passing through the cathode are recycled, thereby enabling reaction between residual oxygen in the recycled fluid and fuel that has been introduced into the recirculation loop until substantially all the oxygen is reacted, leaving a substantially oxygen-free, predominantly nitrogen compound in the cathode and related flow path. Thereafter, this compound can be redirected to purge the remaining residual hydrogen resident in the fuel cell's anode and related flow path. A combustor 370 and a heat exchanger 390 (FIG. 2A of the '682 application) are employed as part of the oxygen depletion phase. An oxygen sensor 380 monitors the oxygen levels in the recirculating cathode flow path to determine when the oxygen has been depleted.

Such fuel cell shutdown processes and systems are, however, complex and require various components, such as the combustor, the heat exchanger, and the oxygen sensor. Furthermore, the shutdown method of the '682 application may potentially degrade fuel cell components because combustion proceeds in the cathode during the depletion of oxygen. Moreover, introduction of reactant into the cathode flow path to facilitate oxygen depletion therein degrades fuel efficiency.

Accordingly, although there have been advances in the field, there remains a need in the art for increasing fuel cell efficiency and for simplifying the fuel cell shutdown process. The present invention addresses these needs and provides further related advantages.

### BRIEF SUMMARY OF THE INVENTION

In brief, the present invention is directed to a method and system for implementing a fuel cell shutdown process. Briefly described, one embodiment of a method for implementing a fuel cell system shutdown process wherein during normal operation of a fuel cell stack of the fuel cell system, an oxidant is supplied to a cathode of the fuel cell stack via a cathode flow path and a fuel is supplied to an anode of the fuel cell stack via an anode flow path to generate electrical power, the method comprising establishing an oxidant recirculation path from a portion of the cathode flow path upon initiation of the fuel cell shutdown process, recirculating the oxidant through the oxidant recirculation path during an oxygen depletion phase to substantially deplete oxygen residing therein to form a substantially oxygen-free fluid, establishing an anode purge path from a portion of the cathode flow path and the anode flow path, wherein the anode purge path is established upon completion of the oxygen depletion phase, and transferring the substantially oxygen-free fluid through the anode purge path to substantially purge out the fuel in the anode during a purge phase. In a further embodiment, the oxygen depletion phase is established and the anode purge phase is controlled if a detected output parameter is equal to or greater than a predetermined threshold.

Another embodiment may be briefly described as a fuel cell system comprising a fuel cell stack comprising at least one fuel cell, the at least one fuel cell comprising an anode and a cathode; an anode flow path operable to provide a fuel to the anode during an electrical generation phase; a cathode flow path operable to provide an oxidant to the cathode during the electrical generation phase; an oxidant recirculation path established from a portion of the cathode flow path during an oxygen depletion phase, and operable to recirculate the oxidant fluid through the cathode to form a substantially oxygen-free fluid during an oxygen depletion phase; and an anode purge path established from the portion of the cathode flow path and a portion of the anode flow path, and operable to transfer the substantially oxygen-free fluid through the anode after conclusion of the oxygen depletion phase such that the fuel in the anode is purged therefrom.

In a further embodiment, a diverter valve between the anode flow path and the oxidant flow path is operable to at least a first state, second state and a third state; wherein when the diverter valve is in the first state, a portion of a cathode flow path is established between the cathode and the outlet, and the anode flow path and the cathode flow path are separated by the diverter valve; wherein when the diverter valve is in the second state, an oxidant recirculating path is established such that oxidant fluid, such as air, is circulatable through at least a portion of the cathode flow path and the cathode of the fuel cell to deplete oxygen in the oxidant fluid to form a substantially oxygen-free fluid therein during an oxygen depletion phase, and the anode flow path and the cathode flow path are separated by the diverter valve; and wherein when the diverter valve is in the third state, a portion of the anode purge path is established by fluidly connecting the anode flow path and the oxidant recirculating path by the diverter valve via the anode purge path to substantially displace residual fuel in at least the anode with the substantially oxygen-free fluid during an anode purge phase.

Yet another embodiment may be briefly described as a fuel cell system comprising an anode flow path operable to transfer a fuel fluid to an anode of the fuel cell during an electrical generation phase, a cathode flow path operable to transfer an oxidant fluid to a cathode of the fuel cell during the electrical generation phase, an oxidant recirculation path established from a portion of the cathode path during an oxygen depletion phase, and operable to recirculate the oxidant fluid through the cathode to form a substantially oxygen-free fluid therein during an oxygen depletion phase, and an anode purge path established from the portion of the cathode path and a portion of the anode path, and operable to transfer the oxygen-free fluid through the anode after conclusion of the oxygen depletion phase such that the fuel fluid in the anode is purged from the anode.

These and other aspects of the invention will be evident upon reference to the following detailed description and attached drawings.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements, as drawn, are not intended to convey any information regarding the actual shape of the particular elements, and have been solely selected for ease of recognition in the drawings.

FIG. 1 is a simplified block diagram of an embodiment of a fuel cell system configured for a normal operating mode, wherein electrical power is generated by fuel cell.

FIG. 2 is a simplified block diagram of an embodiment of a fuel cell system 100 configured for an oxygen depletion phase of the shutdown process.

FIG. 3 is a simplified block diagram of an embodiment of a fuel cell system configured for an anode purge phase of the shutdown process.

FIG. 4 is a block diagram illustrating selected components of the valve controller of FIGS. 1-3.

FIG. 5 is a flowchart illustrating a shutdown process used by an embodiment of the fuel cell system.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fuel cell systems have not been shown or described in detail to avoid unnecessarily obscuring descriptions of the embodiments of the invention.

The embodiments described herein facilitate shutdown of a fuel cell system comprising a fuel cell stack, such as, but not limited to, a proton exchange membrane (PEM) fuel cell stack. The shutdown process begins in one exemplary embodiment by terminating the generation of electrical energy to a primary load, followed by the depletion of oxygen from an oxidant fluid in a cathode flow path that includes a plurality of cathode flow fields of the fuel cell stack (hereinafter referred to as the oxygen depletion phase).

In the various embodiments, the oxidant fluid in the cathode flow path is initially air. The level of oxygen in the cathode flow path is depleted without the addition of a reactant, such as hydrogen or the like, into the cathode flow path. During the oxygen depletion phase, oxygen is depleted from the cathode flow path by on-going electrical energy generation by reacting with the residual fuel in an anode flow path, the anode flow path comprising a plurality of anode flow fields of the fuel cell stack. The oxidant fluid may be recirculated to the cathode flow fields, for example, via an oxidant recirculation path that forms part of the cathode flow path. The electrical energy generated may be used to power primary loads and/or other fuel cell system components, such as, but not limited to, an oxidant compressor 120. Alternatively, or additionally, the electrical energy generated may be stored into a suitable energy storage device, such as, but not limited to, a battery, super-capacitor or the like.

Once oxygen in the cathode flow path is sufficiently depleted, the remaining fluid in the cathode flow path is substantially oxygen-free and substantially inert. In one embodiment, the substantially oxygen-free fluid in the cathode flow path contains preferably less than four percent weight (4 wt %) oxygen, and more preferably less than one percent weight (1 wt %) oxygen. In another embodiment, the substantially oxygen-free fluid is substantially nitrogen.

The substantially oxygen-free fluid is then used to displace the residual fuel in the anode flow path (hereinafter referred to as the anode purge phase). As described in greater detail below, an oxidant recirculation path is formed from a portion of the cathode flow path including the plurality of cathode flow fields, to facilitate oxygen depletion throughout the oxidant recirculation path, thereby creating a substantially oxygen-free fluid therein.

In one embodiment, oxidant is not substantially supplied to the oxidant recirculation path during the oxygen depletion phase. In another embodiment, oxidant is drawn from the air supply source only to replace the oxygen that is consumed during the oxygen depletion phase.

In one embodiment, fuel is not substantially supplied to the anode flow path upon disconnection of the primary load. Thus, fuel efficiency is improved over prior art fuel cell shutdown systems because a much smaller amount of fuel is consumed because fuel does not need to be provided from the fuel supply source into the oxidant recirculation path to consume the oxygen therein, prior to recirculating back into the anode flow path to displace residual fuel therein with the substantially oxygen-free (and inert) fluid from the oxidant recirculation path. In another embodiment, fuel is supplied to at least the anode flow fields for at least a portion of the oxygen depletion phase to substantially consume the oxygen from the oxidant recirculation path.

In some embodiments, during the shutdown process, one or a combination of output parameters of the fuel cell and/or fuel cell system may be monitored and/or detected. As the oxygen depletion phase proceeds, the oxidant fluid is continuously recirculated in the oxidant recirculation path to substantially consume the oxygen therein. Accordingly, electrical energy generation from the fuel cell gradually decreases as oxygen in the cathode flow fields and hydrogen in the anode flow fields are simultaneously consumed. When the detected output parameter(s) of the fuel cell stack reach(es) a predetermined threshold value during the oxygen depletion phase, a control system determines that the oxygen depletion phase has been sufficiently completed such that substantially inert fluids reside in the oxidant recirculation path. The anode purge phase can then begin. Similarly, when the detected output parameter(s) of the fuel cell stack reach(es) a predetermined threshold value during the anode purge phase, a control system determines that the anode purge phase has been sufficiently completed such that substantially inert fluids reside in the anode flow path.

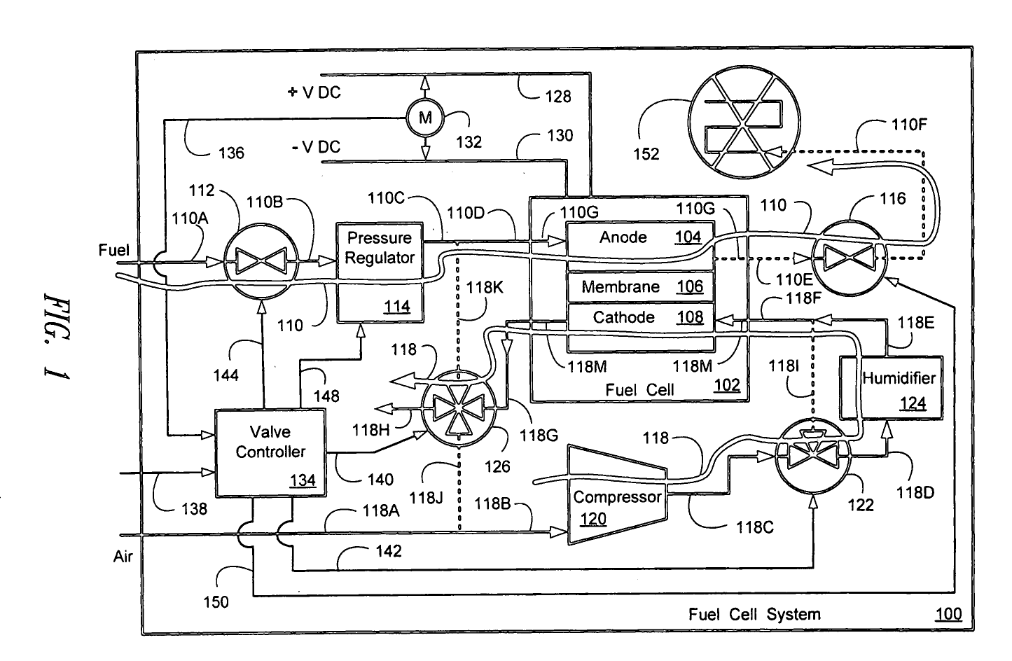

FIG. 1 is a simplified block diagram of an embodiment of a fuel cell system 100 configured in a normal operating mode wherein electrical power is generated by fuel cell stack 102. For convenience, the flow paths described hereinbelow which are open, or which are active or fluidly connected to at least one adjacent flow path, are illustrated in the figures using solid lines. Inactive flow paths, or closed or isolated flow paths, are illustrated with dashed lines. It is appreciated that the flow paths illustrated in FIG. 1 correspond to a normal operating condition wherein fuel cell stack 102 is generating electrical power. As described in greater detail below, flow paths are reconfigured for the shutdown process of fuel cell stack 102.

The exemplary fuel cell stack 102 comprises at least one fuel cell comprising an anode 104, a cathode 108 and a membrane 106. Fuel cell stack 102 may comprise any type of suitable fuel cell, such as a PEM fuel cell or the like. Anode 104 and cathode 108 comprises at least one flow field channel 110G, 118M for directing the flow of reactants, such as fuel and air, and/or products into and out of fuel cell stack 102.

During normal fuel cell operation, a fuel, such as hydrogen or the like, is supplied to anode 104 via anode flow paths 110A-D. After consumption of all or at least a substantial portion of the fuel, the fluid in the anode 104 is released from anode 104 to anode flow paths 110E and 110F. Anode flow paths 110A-110G collectively form the anode flow path represented by arrow 110. In the exemplary embodiment, hydrogen is used as the fuel. Other suitable fuels may be used in other embodiments.

A fuel inlet valve 112 and/or a pressure regulator 114 may be used to control flow and/or pressure of the fuel in anode flow paths 110A-D, wherein fuel is supplied from a fuel supply source (not shown). For convenience, the illustrated fuel cell stack 102 is operating in a dead-ended or closed mode of operation. Accordingly, a fuel outlet valve 116 is closed such that there is no fluid flow along the anode flow path 110E and 110F (denoted by the dashed lines of anode flow paths 110E and 110F in FIG. 1). Fuel outlet valve 116 may open periodically to release or purge out inert fluids that build up in anode 104 over time. Alternative embodiments of the fuel cell system 100 may be configured to operate with fuel cell stacks that use other modes of anode operation.

An oxidant, such as air, is supplied to the cathode 108 via cathode flow path represented by arrow 118, collectively formed by the paths 118A-F and 118M. The incoming air, now referred to for convenience as an oxidant fluid, has a portion of the oxygen removed during the electrical power generation process. At some later point in time, the oxidant fluid is released from cathode 108 via cathode flow paths 118G and 118H during normal operation so that it can be replaced with air from an air source (not shown) having a relatively greater amount of oxygen.

The exemplary cathode flow paths 118A-H may include a compressor 120, a first diverter valve 122, a humidifier 124 and/or a second diverter valve 126. Compressor 120 provides a suitable pressure along path 118A-H so that the oxidant is supplied to the cathode 108. Alternatively, at least one of a blower, a fan, an ejector, and a pump may replace or be used in conjunction with compressor 120. First diverter valve 122 directs flow of air into humidifier 124, as denoted by the solid lines of cathode flow paths 118D-F in FIG. 1. At the same time, second diverter valve 126 is actuated to fluidly connect cathode flow path 118H to cathode flow path 118G so that residual air may be vented out from cathode 108 through an outlet, such as, but not limited to, a vent, an exhaust system, or the like (not shown).

The above-described components in cathode flow paths 118A-C may be optional, or may be in different order, or may be operated differently during normal operation, depending upon the embodiment. For example, if humidifier 124 is optional, diverter valve 122 and humidifier 124 (and flow paths 118D-F) may be omitted. If humidifier 124 is included, but not used at some point during operation, diverter valve 122 may be actuated to substantially isolate cathode flow path 118D and open path 118I to by-pass humidifier 124.

Electrical output of fuel cell stack 102 is provided on connections 128 and 130, which corresponds to the positive direct current (DC) voltage (+V DC) and the negative DC voltage (−V DC), respectively. Detector 132 detects one or more output parameters on at least one of the connections 128, 130. For example, DC current on either or both of connections 128, 130 may be monitored. Alternatively, power and/or voltage and/or resistance may be detected. Any suitable parameter may be detected by detector 132. Detector 132, in this simplified example, is configured to generate a signal having predetermined information corresponding to the detected output parameter, and communicates the signal to valve controller 134 via connection 136, for at least the reasons described in greater detail below. Furthermore, other embodiments may detect a plurality of output parameters. Note that detector 132 may also be a gas sensor (not shown) in at least one of the anode flow paths or the cathode flow paths to detect concentration of at least one of hydrogen, oxygen, or nitrogen therein.

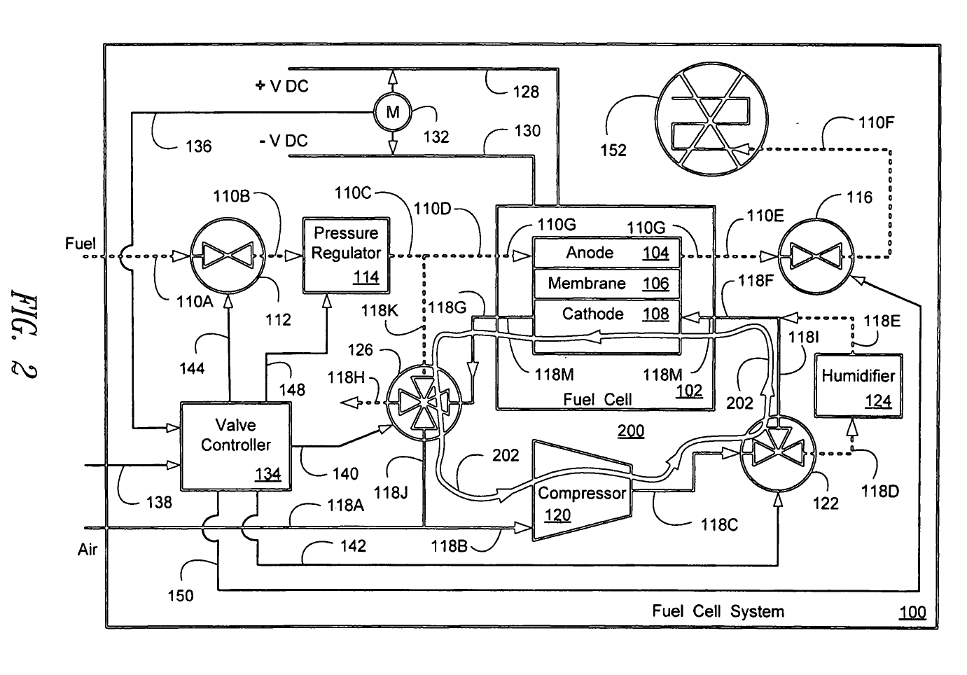

FIG. 2 is a simplified block diagram of an embodiment of the fuel cell system 100 configured for oxygen depletion phase 200 of the shutdown process. Oxygen depletion phase 200 is initiated upon receipt by valve controller 134 of a suitable signal from an external source, via connection 138, corresponding to a request or instruction to stop electrical power generation by fuel cell stack 102 by, for example, but not limited to, disconnection of a primary load. During the oxygen depletion phase, valve controller 134 generates signals to control fuel inlet valve 112, fuel outlet valve 116, first diverter valve 122, and second diverter valve 126, thereby opening or closing the above-described flow paths 110A-F and 118A-H, to change from the above normal operating configuration of the flow paths to an oxygen depletion phase configuration of the flow paths, as described below. Note that pressure regulator 114 may also be controlled by valve controller 134 during oxygen depletion phase 200.

In this exemplary oxygen depletion phase 200, valve controller 134 generates and communicates a control signal to control diverter valve 126, via connection 140, so that cathode flow paths 118J and 118G are opened, or, in other words, fluidly connected to at least one of cathode flow paths 118A and 118B, as denoted by solid lines in FIG. 2. Cathode flow paths 118H and 118K are closed, or, in other words, substantially isolated from cathode flow paths 118G and 118J, as denoted by dashed lines in FIG. 2.

In some embodiments having humidifier 124, a signal may be generated and communicated to control diverter valve 122, via connection 142, so that path 118I is opened. Thus, path 118I becomes fluidly connected to cathode flow paths 118C and 118F, as denoted by solid lines in FIG. 2. Cathode flow paths 118D and 118E become closed, as denoted by dashed lines in FIG. 2. Accordingly, an oxidant recirculation path 202, comprising cathode flow paths 118B, 118I, 118F, 118G and 118J, is established such that the oxygen depletion phase begins.

In another embodiment, cathode flow paths 118D and 118E may remain part of oxidant recirculation path 202. Accordingly, cathode flow path 118I is substantially isolated from the oxidant recirculation path 202 by control of diverter valve 122.

The phrase “substantially isolated” as used herein may refer to inadvertent flows, such as, but not limited to, leaks along a path or in a valve. Also, the phrase “substantially isolated” may encompass complete isolation of flows.

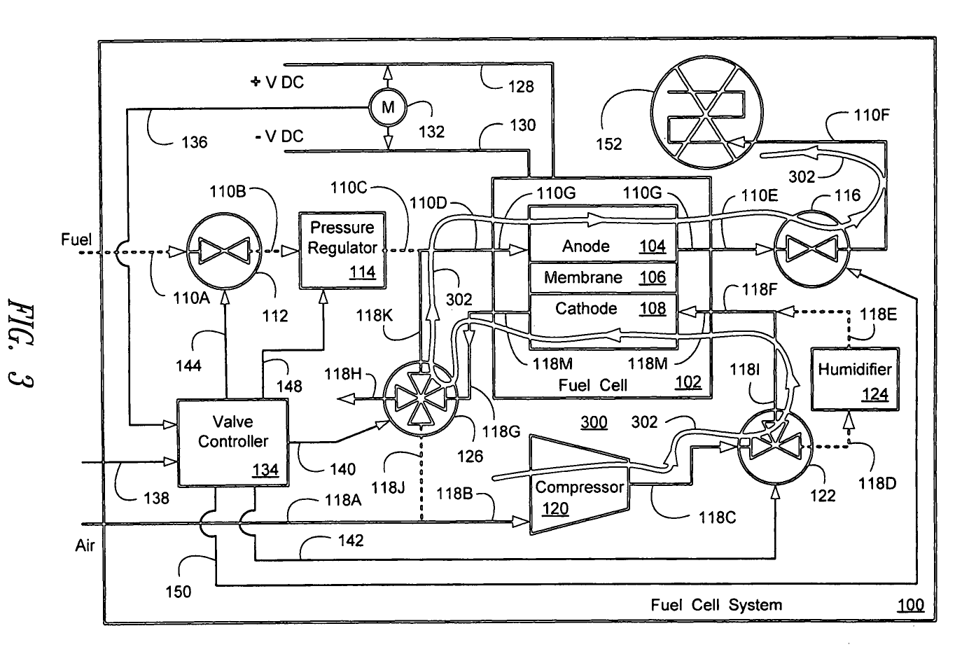

Assuming that sufficient reactant is available in anode 104 for oxygen depletion, valve controller 134 generates and communicates a control signal to control fuel inlet valve 112, via connection 144, so that anode flow path 110A is effectively closed or substantially isolated from anode flow path 110B via fuel inlet valve 112, as denoted by the dashed lines in FIG. 2. This may be accomplished by sufficiently pressurizing the fuel prior to shutdown to provide enough reactant to substantially consume all of the oxygen in oxidant recirculation path 202. Accordingly, fuel is not supplied from the fuel supply source to anode 104. As the oxygen depletion phase proceeds, the pressure in the anode flow paths drop. In other embodiments, valve controller 134 may generate and communicate a signal to control fuel inlet valve 112 and/or pressure regulator 114 (via connection 148, if present) to stop or reduce reactant flow to anode 104 during oxygen depletion phase 200. Thus, fuel efficiency is improved by reducing the amount of reactant purged during anode purge phase 302 (FIG. 3). In yet other embodiments, valve controller 134 does not generate a control signal to control fuel inlet valve 112 and/or pressure regulator 114 and, thus, reactant is supplied to anode 104 during the oxygen depletion phase.

As oxygen depletion phase 200 begins, the reaction between air residing in cathode 108 and fuel residing in anode 104 causes the oxygen in cathode 108 and hydrogen in anode 104 to be consumed. Compressor 120 is operated to circulate the oxidant (now becoming gradually depleted of oxygen as the fluid is circulated through the cathode 108) through oxidant recirculation path 202.

As the oxygen depletion phase proceeds, the gradual depletion of oxygen in the oxidant fluids in oxidant recirculation path 202, and thus cathode 108, causes a reduction in electrical output of the fuel cell stack 102. That is, because less oxygen is available in cathode 108, generation of electrical power decreases. This reduction in electrical output of the fuel cell stack 102 is detected by detector 132, which may be detecting one or more output parameters on connections 128 and/or 130.

As the oxygen depletion phase proceeds to conclusion, the relative percentage of inert gases, such as nitrogen, in the oxidant fluid in oxidant recirculation path 202 increases. At some predetermined level of inert fluid in oxidant recirculation path 202, it is determined that anode purge phase 302 (FIG. 3) of the shutdown process may begin. That is, at some point, the inert or the substantially oxygen-free fluid in oxidant recirculation path 202 may be used to displace residual fuel from anode 104. Anode purge phase 302 is described in greater detail below.

It is appreciated that as the depletion of oxygen proceeds in oxidant recirculation path 202, the volume of fluid in the oxidant recirculation path 202 would decrease because oxygen in the oxidant fluid is consumed, thus creating a vacuum in oxidant recirculation path 202. However, as the fluid volume decreases during the oxygen depletion phase, oxidant recirculation path 202 may draw in a small amount of fresh air from the oxidant supply source (not shown) via path 118A. Thus, if a 1.0 per unit (p.u.) volume of oxygen is drawn out from the fluid during an incremental time period, the volume of depleted oxygen is replaced by a 1.0 p.u. volume of fresh air. Note, however, that since the replacement air has only a limited amount of oxygen (approximately 21% oxygen and 79% inert gasses), the amount of oxygen added to the recirculating oxidant fluid will be small. Accordingly, the added oxygen may be consumed by continuous recirculation of the recirculating oxidant fluid through the oxidant recirculation loop. The volume of the additional fresh air needed to replace the consumed oxygen will continuously decrease as oxygen in the additional fresh air is continuously consumed from oxidant recirculation path 202. One of ordinary skill in the art will recognize that at some point, only an infinitely small amount of fresh air is drawn from the oxidant supply source and a substantially oxygen-free fluid will reside in oxidant recirculation path 202.

Conclusion of the oxygen depletion phase can be determined by monitoring and/or detecting at least one output parameter from the fuel cell stack. Valve controller 134, in this exemplary embodiment, compares information corresponding to one or more detectable parameter(s) with a predetermined threshold value. When the value of the detected output parameter reaches the predetermined threshold value, valve controller 134 may determine that oxygen depletion phase 200 has come to completion. Accordingly, when the detected output parameter reaches the predetermined threshold value, the relative percentage of inert gases in the fluids residing in oxidant recirculation path 202 has reached a suitable level for use in purging anode 104. Accordingly, anode purge phase 302 (FIG. 3) may begin.

In other embodiments, other systems, devices, and/or means may be used to detect conditions which may be used to determine completion of the oxygen depletion phase, such as the use of gas sensors in anode 104 and/or cathode 108. Accordingly, when such systems, devices, and/or means are used, anode purge phase 302 (FIG. 3) may be initiated based on the detection.

FIG. 3 is a simplified block diagram of an embodiment of a fuel cell system 100 configured for anode purge phase 300 of the shutdown process. Anode purge phase 300 of the shutdown operation is initiated, as noted above, when the value of the detected output parameter is equal to or greater than a predetermined threshold value. During anode purge phase 300, valve controller 134 generates signals to control fuel inlet valve 112, pressure regulator 114, fuel outlet valve 116 and diverter valve 126, thereby opening or closing at least one of the above-described anode flow paths 110A-F, and at least one of cathode flow paths 118A-H, to change from the oxygen depletion phase configuration, wherein oxygen is depleted and a substantially oxygen-free fluid is generated in oxidant recirculation path 202 as shown in FIG. 2, to an anode purge phase configuration, as described below.

In this simplified exemplary anode purge phase 300, valve controller 134 generates and communicates a control signal to control diverter valve 126, via connection 140, so that cathode flow paths 118G and 118K are fluidly connected, as denoted by solid lines in FIG. 3, thereby creating anode purge path 302. Cathode flow paths 118H and 118J are substantially isolated via diverter valve 122, as denoted by dashed lines in FIG. 3, which is also controlled by valve controller 134. Further, valve controller 134 generates and communicates a control signal to fuel outlet valve 116, via connection 150, so that flow paths 110E and 110F are fluidly connected to anode 104, as denoted by solid lines in FIG. 3. Accordingly, anode purge path 302 is established via cathode flow paths 118B, 118C, 118I, 118F, 118G, and 118K, and anode flow paths 110D-F.

The substantially oxygen-free fluid residing in oxidant recirculation path 202, as shown in FIG. 2, substantially displaces residual fuel in anode 104 and anode flow paths 110D-F by means of a compressor, blower, fan, pump, ejector, or the like, in oxidant recirculation path 202, as described below. In one embodiment, the cathode flow path volume is larger than the anode flow path volume to substantially displace residual fuel in anode 104 and anode flow paths 110D, 110E, and 110F. Note, however, that the amount of substantially oxygen-free fluid that is transferred from oxidant recirculation path 202 of FIG. 2 may be replaced by additional oxidant fluid, which may be supplied from an oxidant supply source (not shown), such as the air supply source, via cathode flow paths 118A and 118B. Thus, in this example, during the anode purge phase, oxidant or fresh air may enter into at least one of cathode 108 and cathode flow paths 118A, 118B, 118C, 118I, 118F, and 118G via the oxidant supply source upstream of cathode flow path 118A. In one embodiment, the anode purge phase proceeds until anode flow path 110D and anode 104 are substantially filled with oxygen-free fluid. In a further embodiment, the anode purge phase proceeds until anode flow paths 110E and 110F are at least partially filled with the oxygen-free fluid. Alternatively, no additional oxidant fluid is added to oxidant recirculation path 202, thereby creating a partial vacuum therein when the substantially oxygen-free fluid is at least partially transferred to anode 204 via anode purge path 302.

Thus, upon conclusion of the anode purge phase, in one embodiment, anode 104 is substantially filled with oxygen-free fluid. In another embodiment, cathode 108 is substantially filled with oxygen-free fluid. Yet in another embodiment, at cathode 108 is at least partially filled with oxidant fluid.

In the simplified exemplary embodiment of fuel cell system 100 of FIGS. 1-3, compressor 120 drives the substantially oxygen-free gases residing in cathode 108 and cathode flow paths 118B, 118C, 118I, 118F, and 118G to be moved through anode 104, flow path 118K and anode flow paths 110D, 110E, and 110F, thereby displacing any residual reactants residing in anode 104, flow path 118K and at least one of anode flow paths 110D, 110E, and 110F. Alternatively, a blower, fan, pump, ejector, or the like may be used instead of or in conjunction with compressor 120.

Additionally, the simplified exemplary embodiment of the fuel cell system 100 of FIGS. 1-3 comprises an optional reactant diffuser 152 to facilitate dissipation of the displaced fuel. Residual reactants, such as hydrogen, residing in the displaced fuel will be diffused within reactant diffuser 152 to reduce the concentration of hydrogen in the purged fluid. Alternatively, reactant diffuser 152 may be contained or integrated into a radiator fan or the like. Other devices receiving purged fluids via anode flow path 110E may be used by other embodiments, such as, but not limited to, a catalytic device and/or an exhaust system. Other embodiments may omit reactant diffuser 152 and/or other devices, and purge the fluids directly into the atmosphere, particularly if the hydrogen in the fuel is substantially consumed during the oxygen depletion phase.

It is appreciated that the above-described exemplary shutdown process, wherein control fuel inlet valve 112, pressure regulator 114, fuel outlet valve 116, and diverter valves 122 and 126 are actuated by valve controller 134, is intended to be generally representative of one possible shutdown process. Other embodiments may actuate pressure regulator 114, and/or valves 112, 116, 122 and/or 126 in different order, or concurrently with each other, than the above-described order of control valve actuation.

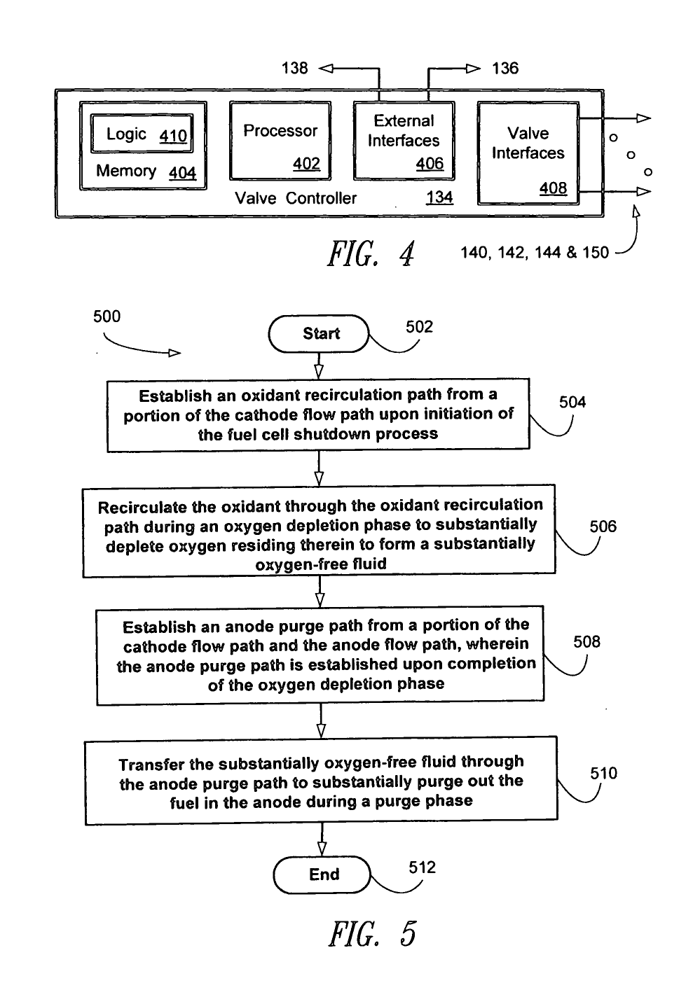

FIG. 4 is a block diagram illustrating selected components of the valve controller 134 of FIGS. 1-3. Valve controller 134 comprises processor 402, memory 404, one or more external interfaces 406, and valve interfaces 408. Logic 410 resides in memory 404 in this simplified exemplary embodiment.

The above-described signal to initiate the shutdown process, and/or the above-described signal corresponding to the detected output parameter from detector 132, in FIGS. 1-3, are received by valve controller 134 via external interface(s) 406, coupled to connections 138 and 136, respectively. The above-described signal communicated by valve controller 134 to pressure regulator 114 and valves 112, 116, 122 and 126, via connections 144, 150, 142 and 140, respectively, are transmitted via valve interface(s) 408. Accordingly, various embodiments of valve controller 134 may be configured to receive signals from and/or transmit signals to other devices in a suitable data format.

Logic 410 is retrieved from memory 404 and executed by processor 402. In accordance with the instructions of logic 410, valve controller 134 initiates oxygen depletion phase 200, as shown in FIG. 2, in response to receiving the signal to initiate the shutdown process. That is, the above-described signals are generated and communicated to pressure regulator 114 and/or valves 112, 116, 122 and/or 126. Then, valve controller 134 compares the detected electrical output parameter with the corresponding threshold during oxygen depletion phase 200 to determine when the oxygen depletion phase is completed. Upon a determination that oxygen depletion phase 200 has been completed, valve controller 134 initiates anode purge phase 302, as shown in FIG. 3, by communicating the above-described signals to pressure regulator 114 and/or valves 112, 116, 122 and/or 126. These and other components, not shown, of valve controller 134 may be communicatively coupled together via a suitable communication bus (not shown).

Processor 402 is any suitable commercially available processor or a specially designed and/or fabricated process device. Processor 402 controls the execution of a program, employed by embodiments of the fuel cell system 100, in accordance with logic 410. Furthermore, for convenience of illustration in FIG. 4, processor 402, memory 404 and logic 410 are shown residing in the valve controller 134. Processor 402, memory 404 and/or logic 410 may reside in alternative convenient locations outside of valve controller 134, as components of other systems, or as stand alone dedicated elements, without adversely affecting the operation and functionality of the power budgeting apparatus and method.

When logic 410 is implemented as software and stored in memory 404, it is appreciated that logic 410 can be stored on any computer-readable medium for use by or in connection with any computer and/or processor related system or method. In the context of this document, a memory 404 is a computer-readable medium that is an electronic, magnetic, optical, or other another physical device or means that contains or stores a computer and/or processor program. Logic 410 can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic 410. In the context of this specification, a “computer-readable medium” can be any means that can store, communicate, propagate, or transport the program associated with logic 410 for use by or in connection with the instruction execution system, apparatus, and/or device. The computer-readable medium can be, for example, but not limited to, an electronic, magnetic, optical, electromagnetic, infrared, or semiconductor system, apparatus, device, or propagation medium. More specific examples (a nonexhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic 410 is printed, as the program can be electronically captured, for instance, via optical scanning of the paper or other medium, then compiled, interpreted, or otherwise processed in a suitable manner, if necessary, and then stored in memory 404.

Valve controller 134 is illustrated as residing within the fuel cell system 100. Valve controller 134 may reside in alternative convenient locations outside of fuel cell system 100, either as a component of other systems, or as a stand-alone dedicated unit, without adversely affecting the operation and functionality of the various embodiments of the fuel cell system 100.

In an alternative embodiment, valve controller 134 generates and communicates a signal to compressor 120 to adjust (increase, decrease and/or stop) air flow during the oxygen depletion phase.

Valve controller 134 was described above as a dedicated controller for control of the shutdown process. In other embodiments, valve controller 134 may have other functions in addition to the above-described functions associated with the fuel cell shutdown process. For example, valve controller 134 may generate and communicate signals causing valve 122 to bypass the humidifier during normal operation. Valve controller 134 may generate and communicate signals to other devices. That is, valve controller 134 may be a multi-function device or a general purpose controller system.

In another embodiment, valve controller 134 generates and communicates a signal to pressure regulator 114 so that valve 112 remains open, but is throttled so that only a sufficient level of reactant is maintained in the anode 104 for depletion of oxygen from oxidant recirculation path 202 during oxygen depletion phase 200. Throttling may be variable so that the amount of reactant added to anode 104 corresponds to remaining oxidant in oxidant recirculation path 202.

FIG. 5 is a flow chart 500 illustrating a process used by an embodiment of fuel cell system 100. Flow chart 500 shows the architecture, functionality, and operation of a possible implementation of the software for implementing logic 410 (FIG. 4). In this regard, each block may represent a module, segment, or portion of code, which comprises one or more executable instructions for implementing the specified logical function(s). It should also be noted that in some alternative implementations, the functions noted in the blocks may occur out of the order noted in FIG. 5 or may include additional functions. For example, two blocks shown in succession in FIG. 5 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The shutdown process begins at block 502. At block 504, an oxidant recirculation path is established from a portion of the cathode flow path upon initiation of the fuel cell shutdown process. At block 506, the oxidant is recirculated through the oxidant recirculation path during an oxygen depletion phase to substantially deplete oxygen residing therein to form a substantially oxygen-free fluid. At block 508, an anode purge path is established from a portion of the cathode flow path and the anode flow path, wherein the anode purge path is established upon completion of the oxygen depletion phase. At block 510, the substantially oxygen-free fluid is transferred through the anode purge path to substantially purge out the fuel in the anode during a purge phase. The process ends at block 512.

Some of the above-described embodiments of fuel cell system 100 were described as having detector 132 and connection 136 residing in the fuel cell system 100. In other embodiments, the output parameter is detected by devices outside of fuel cell system 100 that are used for other purposes. Information from such remote detecting devices may be communicated to valve controller 134 such that a determination can be made regarding the completion of the oxygen depletion phase.

Some of the above-described valves control three or more flow paths. For example, diverter valve 126 controls flow through cathode flow paths 118G, 118H, 118J and 118K. Other embodiments may use a plurality of valves to effect the same functionality of the above-described control valves which control more than three flow paths.

As used herein, the term “fluid” corresponds to gases and/or liquids. Accordingly, the terms “fluid” and the term “gas” (or the like) may be interchangeably used within the specification and/or claims.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/725,857, filed Oct. 12, 2005, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for implementing a fuel cell system shutdown process wherein during normal operation of a fuel cell stack of the fuel cell system, an oxidant is supplied to a cathode of the fuel cell stack via a cathode flow path and a fuel is supplied to an anode of the fuel cell stack via an anode flow path to generate electrical power, the method comprising:
establishing an oxidant recirculation path from a portion of the cathode flow path upon initiation of the fuel cell shutdown process;
recirculating the oxidant through the oxidant recirculation path during an oxygen depletion phase to substantially deplete oxygen residing therein to form a substantially oxygen-free fluid;
establishing an anode purge path from a portion of the cathode flow path and the anode flow path, wherein the anode purge path is established upon completion of the oxygen depletion phase; and
transferring the substantially oxygen-free fluid through the anode purge path to substantially purge out the fuel in the anode during a purge phase.

2. The method of claim 1, further comprising:
terminating the supply of air to the oxidant recirculation path from an air supply source upon initiation of the fuel cell shutdown process.

3. The method of claim 1, further comprising:
generating electrical energy during the oxygen depletion phase.

4. The method of claim 1, further comprising:
supplying the fuel from a fuel supply source to the anode for at least a portion of the oxygen depletion phase.

5. The method of claim 1, further comprising:
terminating supply of the fuel from a fuel supply source to the anode during the oxygen depletion phase.

6. The method of claim 1, further comprising:
substantially isolating the oxidant recirculation path from the anode flow path during the oxygen depletion phase.

7. The method of claim 1, further comprising:
transferring the substantially oxygen-free fluid from the cathode flow path to the anode using a compressor, a blower, a fan, an ejector, or a pump in the oxidant recirculation path.

8. The method of claim 1, further comprising:
detecting at least one output parameter of the fuel cell during the oxygen-depletion phase;
comparing the detected at least one output parameter to at least one predetermined threshold; and
establishing the anode purge path if the detected at least one output parameter is equal to or greater than the at least one predetermined threshold.

9. The method of claim 8 wherein the at least one output parameter is selected from a group consisting of a current, a voltage, a resistance, and a gas concentration.

10. The method of claim 9 wherein the gas concentration is at least one of an oxygen concentration and a nitrogen concentration.

11. The method of claim 8, further comprising:
supplying the fuel from a fuel supply source to the anode for at least a portion of the oxygen depletion phase; and
terminating supply of the fuel to the anode if the detected output parameter is equal to or greater than the at least one predetermined threshold.

12. The method of claim 1, further comprising:
detecting at least one output parameter of the fuel cell during the purge phase;
comparing the detected at least one output parameter to at least one predetermined threshold; and
terminating the transfer of the substantially oxygen-free fluid to the anode flow path if the detected at least one output parameter is equal to or greater than the at least one predetermined threshold.

13. The method of claim 12 wherein the at least one output parameter is selected from a group consisting of a current, a voltage, a resistance, and a gas concentration.

14. The method of claim 13 wherein the gas concentration is a least one of a hydrogen concentration and a nitrogen concentration.

15. The method of claim 1, further comprising:
diluting the purged fuel downstream of the fuel cell.

16. A processor-readable medium storing instructions for causing a processor to implement a shutdown process for a fuel cell system, the fuel cell system comprising at least one fuel cell stack, by:
communicating a first signal to at least one valve to establish an oxidant recirculation path from a portion of a cathode flow path upon initiation of the fuel cell shutdown process, wherein an oxidant fluid is recirculated during an oxygen depletion phase that depletes oxygen residing in the oxidant recirculation path and a cathode of the at least one fuel cell stack to form a substantially oxygen-free fluid in the oxidant recirculation path and the cathode, and wherein an anode flow path is substantially isolated from the oxidant recirculation path; and
communicating a second signal to the at least one valve to establish an anode purge path from a portion of the oxidant recirculation path and the anode flow path, wherein the anode purge path is established upon completion of the oxygen depletion phase, and wherein the substantially oxygen-free fluid is transferred from the oxidant recirculation path to an anode of the at least one fuel cell stack to purge out residual reactant fluids therefrom.

17. The medium of claim 16, further comprising instructions for:
receiving a third signal corresponding to at least one output parameter, the output parameter indicative of at least one of a gas concentration in the fuel cell and an electrical output parameter;
comparing information corresponding to the at least one output parameter to at least one predetermined threshold; and
generating the second signal to establish the anode purge path after the at least one output parameter is equal to or greater than the at least one predetermined threshold.

18. A fuel cell system, comprising:
a fuel cell stack comprising at least one fuel cell, the at least one fuel cell comprising an anode and a cathode;
an anode flow path operable to provide a fuel to the anode during an electrical generation phase;
a cathode flow path operable to provide an oxidant to the cathode during the electrical generation phase;
an oxidant recirculation path established from a portion of the cathode flow path during an oxygen depletion phase, and operable to recirculate the oxidant fluid through the cathode to form a substantially oxygen-free fluid during the oxygen depletion phase; and
an anode purge path established from the portion of the cathode flow path and a portion of the anode flow path, and operable to transfer the substantially oxygen-free fluid through the anode after conclusion of the oxygen depletion phase such that the fuel in the anode is purged therefrom.

19. The fuel cell system of claim 18, further comprising:
a valve between the anode flow path and the oxidant flow path, operable in a first state to isolate the anode flow path from the cathode flow path, operable in a second state to establish the oxidant recirculation path from the portion of the cathode flow path during the oxygen depletion phase, and operable in a third state to establish the anode purge path from the portion of the cathode flow path and a portion of the anode flow path after conclusion of the oxygen depletion phase.

20. The fuel cell system of claim 19, further comprising:
a valve controller controllably coupled to the valve and operable to operate the valve to the first state, the second state and the third state; and
a means for detecting at least one output parameter of the fuel cell and operable to communicate a signal corresponding to the detected output parameter to the valve controller so that the valve controller operates the valve from the second state to the third state after conclusion of the oxygen depletion phase.

21. The fuel cell system of claim 18, further comprising:
a means for providing the oxidant through the cathode flow path during the electrical generation phase, operable to recirculate the oxidant through the oxidant recirculation path during the oxygen depletion phase, and operable to transfer the substantially oxygen-free fluid through the anode purge path after conclusion of the oxygen depletion phase.
